(19) United States
(12) Patent Application Publication
(10) Pub. No.: US 2013/0313914 A1
(43) Pub. Date: Nov. 28, 2013

(54) CONTROL CIRCUIT FOR UNIVERSAL SERIAL BUS CONNECTOR

(71) Applicant: CHUAN-TSAI HOU, Taoyuan (TW)

(72) Inventor: CHUAN-TSAI HOU, Taoyuan (TW)

(73) Assignee: INGRASYS TECHNOLOGY INC., Taoyuan (TW)

(21) Appl. No.: 13/589,241

(22) Filed: Aug. 20, 2012

(30) Foreign Application Priority Data
May 28, 2012 (TW) 101118940

(51) Int. Cl. H01H 47/00

(52) U.S. Cl. 307/115

(57) ABSTRACT

A control circuit for a USB connector includes a first electronic switch. Before a universal serial bus (USB) device is plugged into the USB connector, a ground pin of the USB connector is idle. A control terminal of the first electronic switch receives a high level signal and first and second terminals of the first electronic switch are disconnected. When the USB device is plugged into the USB connector, the ground pin of the USB connector is grounded. The control terminal of the first electronic switch then receives a low level signal and the first and second terminals of the first electronic switch are connected. A power supply connected to the first terminal of the first electronic switch supplies power to the power pin of the USB connector through the first electronic switch.

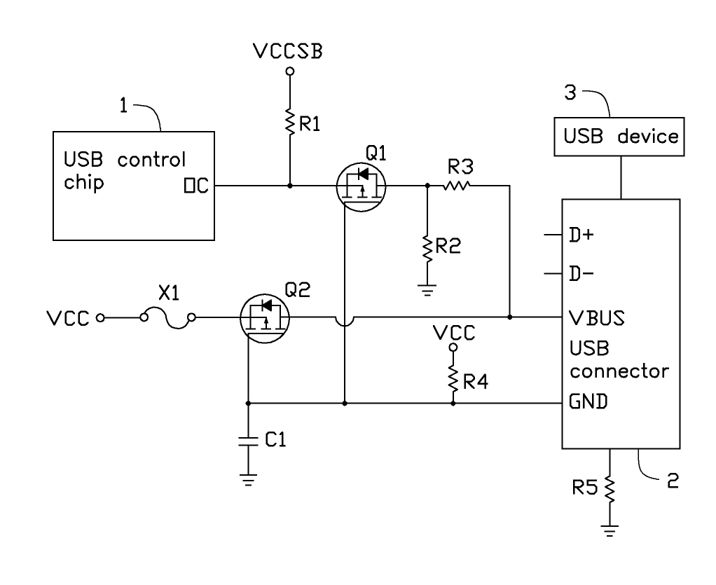

### BACKGROUND

1. Technical Field

The present disclosure relates to a circuit for controlling a universal serial bus (USB) connector.

2. Description of Related Art

When an electronic device is powered on, a USB connector on the electronic device is also being supplied with power. However, at the moment when a USB device is plugged into the USB connector, the USB device may be damaged because of a high current inrush through the USB connector.

### BRIEF DESCRIPTION OF THE DRAWING

Many aspects of the embodiments can be better understood with reference to the drawing. The components in the drawing are not necessarily drawn to scale, the emphasis instead being placed upon clearly illustrating the principles of the present embodiments.

The FIGURE is a circuit diagram of an exemplary embodiment of a USB control circuit.

### DETAILED DESCRIPTION

The disclosure, including the drawing, is illustrated by way of example and not by way of limitation. It should be noted that references to “an” or “one” embodiment in this disclosure are not necessarily to the same embodiment, and such references mean “at least one”.

Referring to the FIGURE, a control circuit is connected between a universal serial bus (USB) control chip 1 and a USB connector 2. An exemplary embodiment of the control circuit includes two P-channel metallic oxide semiconductor field effect transistors (MOSFETs) Q1 and Q2, resistors R1-R5, a capacitor C1, and a fuse X1.

A source of the MOSFET Q1 is connected to a standby power terminal VCCSB on a motherboard through the resistor R1. The source of the MOSFET Q1 is also connected to an overcurrent pin OC of the USB control chip 1. A drain of the MOSFET Q1 is grounded through the resistor R2. The drain of the MOSFET Q1 is further connected to a power pin VBUS of the USB connector 2 through the resistor R3. A source of the MOSFET Q2 is connected to a power supply terminal VCC on the motherboard through the fuse X1. A drain of the MOSFET Q2 is connected to the power pin VBUS of the USB connector 2. Gates of the MOSFETs Q1 and Q2 are connected to the power supply terminal VCC through the resistor R4. The gates of the MOSFETs Q1 and Q2 are grounded through the capacitor C1. The gates of the MOSFETs Q1 and Q2 are further connected to a ground pin GND of the USB connector 2. A base of the USB connector 2 is grounded through the resistor R5. In the embodiment, the standby power terminal VCCSB provides 3.3 volts, and the power supply terminal VCC provides 5 volts.

When a USB device 3 is not plugged into the USB connector 2, the ground pin GND of the USB connector 2 is idle. The gates of the MOSFETs Q1 and Q2 receive high level signals. The MOSFETs Q1 and Q2 are turned off. In this condition, the power supply VCC cannot provide power to the power pin VBUS of the USB connector 2 through the MOSFET Q2. Meanwhile, the overcurrent pin OC of the USB control chip 1 receives a high level signal, such that the USB control chip 1 cannot output overcurrent signals.

When the USB device 3 is plugged into the USB connector 2, the ground pin GND of the USB connector 2 is connected to the base of the USB connector 2. In other words, the ground pin GND of the USB connector 2 becomes grounded. In this condition, the gates of the MOSFETs Q1 and Q2 receive low level signals. The MOSFETs Q1 and Q2 are turned on. The power supply VCC supplies power to the power pin VBUS of the USB connector 2 through the MOSFET Q2.

In the embodiment, the fuse X1 protects the USB device 3 plugged into the USB connector 2 when the current flowing through the USB connector 2 is too great. In detail, when the current flowing through the USB connector 2 is more than 0.5 amperes, the fuse X1 acts as a cut out. The overcurrent pin OC of the USB control chip 1 is grounded through the resistor R2. The USB control chip 1 gives an alarm that excessive current is flowing through the USB connector 2.

In the embodiment, the MOSFETs Q1 and Q2 function as electronic switches.

The foregoing description of the exemplary embodiments of the disclosure has been presented only for the purposes of illustration and description and is not intended to be exhaustive or to limit the disclosure to the precise forms disclosed. Many modifications and variations are possible in the light of everything above. The embodiments were chosen and described in order to explain the principles of the disclosure and their practical application so as to enable others of ordinary skill in the art to utilize the disclosure and various embodiments with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. A control circuit connected between a universal serial bus (USB) control chip and a USB connector, the control circuit comprising:
a first electronic switch, wherein a control terminal of the first electronic switch is connected to a first power supply through a first resistor, the control terminal of the first electronic switch is further connected to a ground pin of the USB connector, a first terminal of the first electronic switch is connected to the first power supply, a second terminal of the first electronic switch is connected to a power pin of the USB connector, a base of the USB connector is grounded; wherein when a USB device is not plugged into the USB connector, the ground pin of the USB connector is idle, the control terminal of the first electronic switch receives a high level signal, the first and second terminals of the first electronic switch are disconnected; wherein when the USB device is plugged into the USB connector, the ground pin of the USB connector is grounded, the control terminal of the first electronic switch receives a low level signal, the first and second terminals of the first electronic switch are connected, the first power supply supplies power to the power pin of the USB connector through the first electronic switch.

2. The control circuit of claim 1, further comprising a second electronic switch, wherein a control terminal of the second electronic switch is connected to the control terminal of the first electronic switch, a first terminal of the second electronic switch is connected to a second power supply through a second resistor, the first terminal of the second electronic switch is further connected to an over current pin of the USB control chip, a second terminal of the second electronic switch is grounded through a third resistor, the second terminal of the second electronic switch is connected to the power pin of the USB connector through a fourth resistor; wherein when the control terminal of the second electronic switch receives a low level signal, the first and second terminals of the second electronic switch are connected; when the control terminal of the second electronic switch receives a high level signal, the first and second terminals of the second electronic switch are disconnected.

3. The control circuit of claim 2, further comprising a fuse connected between the first terminal of the first electronic switch and the first power supply.

4. The control circuit of claim 2, wherein the second electronic switch is a P-channel metallic oxide semiconductor field effect transistor (MOSFET), a gate, a drain, and a source of the MSOFET are respectively the control terminal, and the first and second terminals of the second electronic switch.

5. The control circuit of claim 1, further comprising a capacitor, wherein the control terminal of the first electronic switch is grounded through the capacitor.

6. The control circuit of claim 1, wherein the first electronic switch is a P-channel metallic oxide semiconductor field effect transistor (MOSFET), a gate, a drain, and a source of the MSOFET are respectively the control terminal, and the first and second terminals of the first electronic switch.
